(19) United States
(12) Patent Application Publication
(10) Pub. No.: US 2026/0359127 A1
(43) Pub. Date: Nov. 12, 2026

(54) MULTI-CORE PROCESSING WITH SOFTWARE-BASED SCHEDULER AND PLANNER

(71) Applicant: Siemens Aktiengesellschaft, Munich (DE)

(72) Inventors: Tao Cui, Princeton Junction, NJ (US); Kun Ji, Plainsboro, NJ (US); Caiwu Ding, Hillsborough, NJ (US); Amardeep Manak, Fords, NJ (US)

(73) Assignee: Siemens Aktiengesellschaft, Munich (DE)

(21) Appl. No.: 19/129,856

(22) PCT Filed: Nov. 17, 2022
(86) PCT No.: PCT/US2022/050177

§ 371 Date: May 14, 2025

(51) Int. Cl. G06F 9/50; G06F 11/34

(52) U.S. Cl. CPC G06F 9/5038; G06F 9/5094; G06F 11/3457

(57) ABSTRACT

A multi-core processing system includes a processing unit having a plurality of distinct processing cores, and a memory coupled to the processing unit that includes instructions defining modules executable by the processing unit. The modules include an application program configured to execute one or more processes at runtime, where each process is defined by one or more user-level threads. The modules further include a software scheduler configured to schedule execution of the user-level threads on the processing cores. The software scheduler accesses a hardware limit metric and/or a real time performance metric associated with individual processing cores monitored during runtime. The software scheduler dynamically allocates processing cores to the user-level threads based on the monitored hardware limit metric and/or the real time performance metric associated with the individual processing cores. The user-level threads are dispatched for execution on respective processing cores based on the allocation.

### TECHNICAL FIELD

The present disclosure generally relates to scheduling of software tasks on a multi-core processing system.

### BACKGROUND

Real time systems such as industrial control systems typically include a real time operating system, which may include a scheduler for organizing tasks (e.g., including one or more threads) to be executed on multiple hardware computing nodes (e.g., CPU cores) to meet real time requirements of the tasks based on time and resource constraints. State-of-the-art scheduling methods (e.g., round robin scheduling, priority scheduling, etc.) are primarily based on software and function requirements and do not consider hardware physical constraints. When using a traditional real time scheduler to achieve real time performance, the software at the user-level may not be aware of hardware constraints (e.g., thermal limits of the CPU cores), which can directly cause the lower-level CPU hardware/firmware to shut off, potentially leading to a complete failure of the software. This can be especially catastrophic if the software is used for critical control or safety applications.

### SUMMARY

Briefly, aspects of the present disclosure are directed to a multi-core processing system and method including a software-based dynamic scheduler and planner based on processor hardware constraints and/or real time performance requirements.

According to a first aspect of the disclosure, a multi-core processing system is provided. The multi-core processing system comprises a processing unit comprising a plurality of distinct processing cores, and a memory coupled to the processing unit, the memory comprising instructions defining modules executable by the processing unit. The modules comprise an application program configured to execute one or more processes at runtime, each process defined by one or more user-level threads, and a software scheduler configured to schedule execution of the user-level threads on the processing cores. The software scheduler is configured to access a hardware limit metric and/or a real time performance metric associated with individual processing cores monitored during runtime. The software scheduler is configured to dynamically allocate processing cores to the user-level threads based on the monitored hardware limit metric and/or the real time performance metric associated with the individual processing cores. The software scheduler is configured to dispatch the user-level threads for execution on respective processing cores based on the allocation.

Further aspects of the disclosure are directed to a corresponding method for allocating resources to an application program running on a multi-core processing system, and to a computer program product including instructions executable by a multi-core processing system to carry out such a method.

According to another aspect of the disclosure, a method is provided for allocating resources in a multi-core processing system by building a software task planner during a commissioning phase. The method includes, over a number of iterations: (a) test running one or more application programs on the multi-core processing system using a scheduling policy defined by a set of scheduling parameters to allocate resources of the multi-core processing system to user-level threads of the one or more application programs, wherein scheduling parameters define hyperparameters for the test run, (b) evaluating an optimization objective based on monitoring of a hardware limit metric and/or a real time performance metric associated with individual processing cores, and (c) executing a hyperparameter tuning algorithm to adjust the set of hyperparameters based on the evaluated optimization objective. The iterations result in a set of optimized scheduling parameters defining an optimal scheduling policy. The optimal scheduling policy is configured as a task planner to pre-allocate resources for running the one or more application programs on the multi-core processing system.

Still further aspects of the disclosure are directed to computer program products including instructions executable by a multi-core processing system to carry out the above-described method and its optional embodiments.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 illustrates a multi-core processing system according to one embodiment.

FIG. 2 is a schematic block diagram illustrating a dynamic software scheduler considering hardware constraints of the processing cores, according to an example embodiment.

FIG. 3 illustrates an example of a user-interface displaying monitored per-core temperature in a state-of-the-art processor.

FIG. 4 is a schematic block diagram illustrating a dynamic software scheduler considering real time performance of the processing cores, according to an example embodiment.

FIG. 5 schematically illustrates measurement of deadline misses and jitter for real time tasks.

FIG. 6 is a schematic block diagram of a method for building a software task planner for a multi-core processing system, according to an example embodiment.

### DETAILED DESCRIPTION

Before undertaking the detailed description, it may be beneficial to define certain terms for clarity.

A “process” refers to an instance of an application program being executed by a processing unit. An application program (or “application”) may comprise one or more processes.

A “task” refers to a part of a process that runs on one processing core. A task may include one or multiple threads.

A “thread” refers to a basic sequence of instructions to which a scheduler may allocate processor time. A scheduler may be part of an operating system (OS). A thread may execute any part of a process code and can include parts of the process code currently executed by another thread. In the context of this description, unless otherwise specified, the term “thread” refers to a user-level thread (also called “application thread”). User-level threads are implemented in user space libraries and may be managed and scheduled in the user space of the OS.

In multi-core processing systems, advances in recent OS have made it possible to control a process to run on different processing cores (CPU cores), allowing freedom to schedule a workload on the available CPU hardware. For example, in a real time operating system, tasks can have different states, such as ready, running, suspended, etc. In this case, the OS kernel is typically responsible for scheduling multiple tasks: e.g., when to run, when to suspend and on which CPU cores to run the tasks, to fulfill the functional requirement of the processing system, such as meeting real time deadlines, allowing multitasks, and sharing of hardware resources among multiple tasks.

The CPU hardware may have physical limitations, such as thermal limits. For example, when the hardware is run in extreme conditions, or if a task is too intense and keeps running on one core for too long, then the core may reach its thermal limit. Another example of CPU overheating may involve a situation where a piece of old firmware is run on new CPU hardware. For instance, if the old firmware was developed for a 2-core architecture and the new hardware has 4 cores, there may be overheating problems when the firmware runs on the new hardware with all 4 cores running. In the event of overheating (e.g., thermal hotspots on certain cores), the CPU or OS kernel may implement low level protection mechanisms that can migrate a task from one core to another, or sometimes shut off the CPU entirely.

Hardware schedulers are known, that can schedule CPU cores at hardware level to allow efficient execution of machine code. The OS kernel may also have a scheduler for computing resource sharing among applications. There are also various known schedulers designed for real time computing, e.g. PREEMPT-RT Kernel of Linux, VxWorks® (developed by Wind River Systems), QNX® (developed by Blackberry Limited) etc. However, those schedulers do not consider hardware limits at user software level. This can lead to the above-mentioned scenario, i.e., triggering some low level action that can cause catastrophic impact to the software (e.g. shutoff CPUs).

The embodiments disclosed herein are directed to a software-based dynamic scheduler and planner considering hardware physical constraints and/or real time performance requirements. According to disclosed embodiments, hardware limit monitoring information and/or real time performance monitoring information may be accessed at the user or application level, to facilitate the scheduling and planning of the tasks for a real time system, such as in an industrial control system. The software scheduler can be available to the application, so that the application (including processes and threads) can be intelligently and dynamically scheduled based on the monitored information during runtime. A user-level software, being aware of a monitored hardware limit metric of the individual CPU cores, can act earlier to migrate threads before the low-level protection mechanism of the CPU or OS kernel takes effect, thus obviating some of the above-described scenarios. Furthermore, the user-level software, being aware of a monitored real time performance metric of the individual CPU cores, can intelligently schedule tasks to achieve real time requirements, allowing a real time system to run on a general-purpose OS, such as Linux.

Especially in the context of industrial control systems, it is a trend that control applications are becoming more flexible and dynamic, to realize a more software-defined control system. In a software-defined control system, software modules are not bound to specific hardware, i.e., a same control application can be deployed on different hardware (different computing nodes, different cores, different CPUs). The disclosed embodiments can ensure that while deploying the control applications to a software-defined control system, the hardware constraints and real time performance during runtime are considered at the application level, thus making a software-defined control system suitable for safety and critical control applications while still being open and flexible.

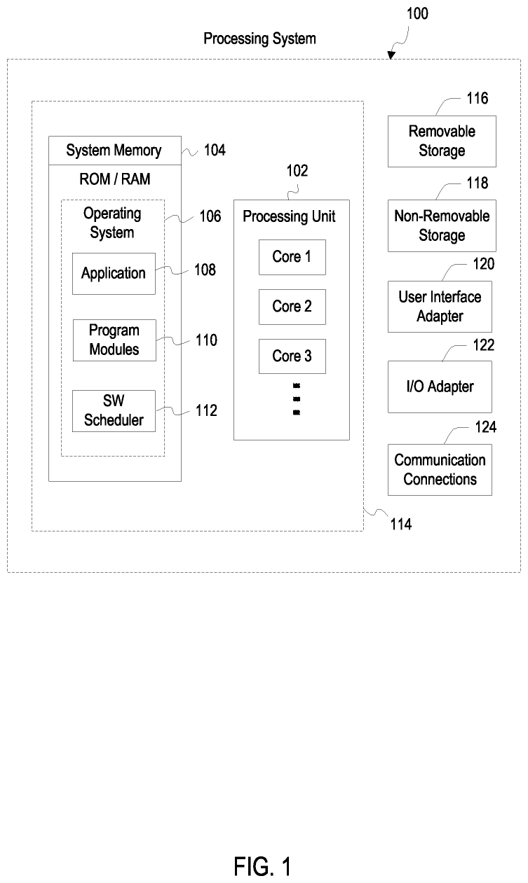

Turning now to the drawings, FIG. 1 illustrates a multi-core processing system 100 that may incorporate aspects of the present disclosure. In one embodiment, the multi-core processing system 100 may include an industrial control system. As shown, the processing system 100 may include at least one processing unit 102 with multiple processing cores and system memory 104. The processing system 100 may also include a plurality of processing units that cooperate in executing programs. Depending on the exact configuration and type of the processing system 100, the system memory 104 may be volatile (such as RAM), non-volatile (such as ROM, flash memory, etc.) or some combination of the two. System memory 104 typically includes an operating system 106, which, according to a disclosed embodiment, may include a general-purpose PC-based OS, such as Linux, among others. In other embodiments, the system memory 104 can include a real time OS, such as VxWorks®, developed by Wind River Systems, among others. The system memory 104 may also include one or more software modules such as an application 108, program modules 110, and a software scheduler 112 running on the operating system 106.

A basic configuration of the processing system 100 is illustrated in FIG. 1 by those components within dashed line 114. The processing system 100 may have additional features or functionality. For example, the processing system 100 may also include additional data storage devices (removable and/or non-removable) such as, for example, hard disks, optical disks, magnetic disks or tapes, flash memory, or other memory technology. Such additional storage is illustrated in FIG. 1 by removable storage 116 and non-removable storage 118. Processing system 100 may include a user interface adapter 120, which may support input and output devices such as keyboard, mouse, pen, voice input device, touch input device, display monitors, audio speakers, etc. Processing system 100 may also include an I/O adapter 122, which may be coupled, for example, to device controllers in a factory automation system. Processing system 100 may additionally include communication connections 124 that allow the processing system 100 to communicate with other devices, such as over a wireless network in a distributed computing environment, for example, an intranet or the Internet, among others.

As disclosed herein, the software scheduler 112 may allocate resources to the application 108 by accessing a hardware limit metric and/or a real time performance metric associated with individual processing cores of the processing unit 102 monitored during runtime. The software scheduler 112 may dynamically allocate processing cores to user-level threads of the application 108, taking into consideration the monitored hardware limit metric and/or the real time performance metric associated with the individual processing cores. The software scheduler 112 may dispatch the user-level threads for execution on respective processing cores based on the allocation.

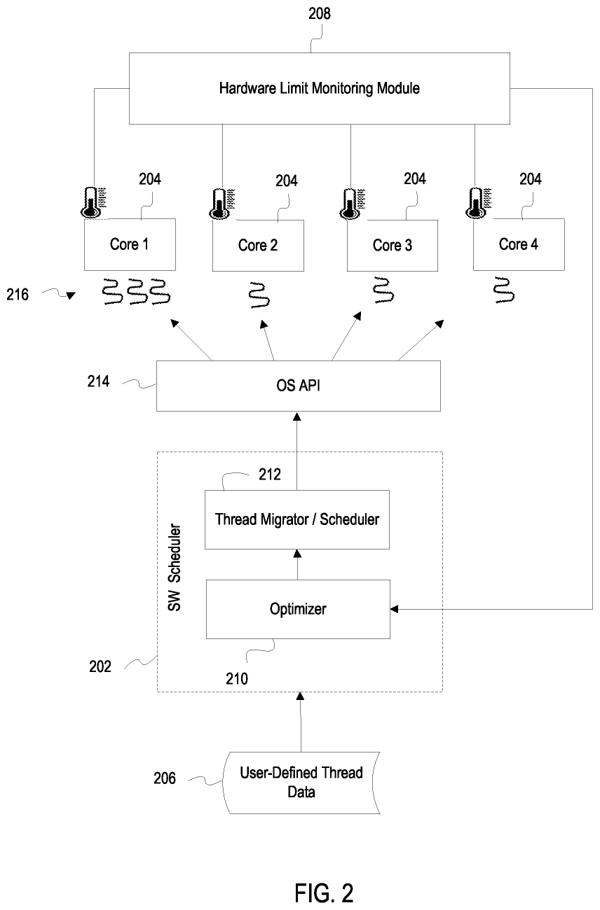

FIG. 2 illustrates a first embodiment of a software scheduler 202 configured to schedule execution of one or more application programs (e.g., control apps) on multiple processing cores 204 of a multi-core processing system, considering hardware constraints of the processing cores 204. Each application program may execute one or more processes at runtime, each process defined by one or more user-level threads. In one embodiment, the software scheduler 202 may be part of a system service that allows a user to define the application threads and set parameters such as core affinity, task priority, task loop time, etc. Accordingly, the software scheduler 202 may have access to user-defined thread data 206 via a user input device. In the disclosed embodiment, the software scheduler 202 runs on a user space of the processing system OS.

As shown, the software scheduler 202 may also have access to a hardware limit metric associated with the individual processing cores 204. According to disclosed embodiments, the hardware limit metric is indicative of a temperature of each processing core 204 (“core temperature”). In the shown example, the individual core temperatures are measured via respective temperature sensors associated with each processing core 204. Alternately or additionally, the hardware limit metric may be monitored based on core voltage and/or core current measurements, for example, via a system environment processor. Voltage and current measurements may capture a more dynamic physical behavior of the hardware and may be further correlated to core temperature. The measurements pertaining to the hardware limit metric (e.g., core temperature, voltage, current, etc.) may be monitored in real time by a hardware limit monitoring module 208. The hardware limit monitoring module 208 may include, for example, a sensor fusion module configured to combine online measurement data from multiple sensors to derive a hardware limit metric for each processing core 204.

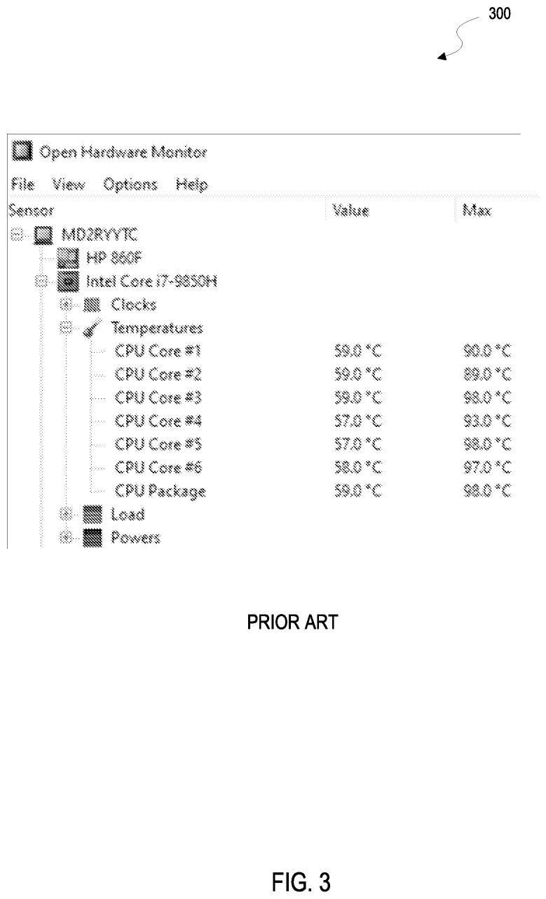

Hardware limit monitoring is available, to an extent, in many state-of-the art multi-core processors. FIG. 3 illustrates an example of a user-interface 300 displaying monitored per-core temperature in a x86 CPU manufactured by Intel Corporation. However, such state-of-the-art measurements are passive with no feedback to a scheduler to adjust a software's behavior to suit different hardware during runtime.

Continuing with reference to FIG. 2, the software scheduler 202 may dynamically allocate processing cores 204 to user-level threads of the one or more application programs taking into consideration the hardware limit metric of the processing cores 204 monitored during runtime. For example, based on the monitored core temperature, the software scheduler 202 can dynamically decide on which core 204 to execute the next tasks to avoid thermal hotspots. The underlying idea is based on the understanding that the amount of heat generated by a core is correlated to its workload, but it is the temperature that is the hard limit of the CPU to throttle or shutoff.

According to the disclosed embodiment, as shown, the software scheduler 202 may comprise a first layer including an optimizer 210 and a second layer including a thread migrator 212. The optimizer 210 may dynamically determine optimal scheduling parameters using the monitored hardware limit metric of the individual processing cores 204. The scheduling parameters may include one or more of the following parameters per thread, namely, processing core to execute on, sleeping time, cyclic time, among others. The optimization problem solved by the optimizer 210 may include determining scheduling parameters that minimize the hardware limit metric (e.g., core temperatures) such that real time performance requirements (e.g., task deadlines) are met. For example, such an optimization problem may be formulated as:

$${min}_{x : \{ Scheduling Parameters \}} {core\_temperature}_{x}$$

$$Such that : real time performance constraints are met , and$$

$$CPU utilization < limit ; CPU temperature < shutoff Temp .$$

In one embodiment, the optimizer 210 may comprise a rule-based optimizer, which may be computationally light and therefore suitable for a runtime scheduler. The rule-based optimizer 210 may be designed based on the above-described optimization problem. As an illustrative example, consider the scenario shown in FIG. 2, where core 1 is assigned three threads and cores 2, 3 and 4 are assigned one thread each. The hardware limit monitoring module 208 may observe that the temperature of core 1 is increasing over time and provide such feedback to the rule-based optimizer 210. Based on the feedback, the rule-based optimizer 210 may determine scheduling parameters to move some of the threads from core 1 to core 3 before a hotspot develops at core 1, while meeting the real time requirements. The hardware limit monitoring module 208 may continuously monitor the impact of each action and provide feedback to the optimizer 210.

The thread migrator 212 may comprise, for example, a state-of-the-art thread scheduling algorithm to dynamically migrate or switch user-level threads 216 to allocated processing cores 204 based on the optimal scheduling parameters determined by the optimizer 210. Based on the output of the thread migrator 212, user-level threads 216 may be dispatched for execution on respective processing cores 204 via a suitable OS API 214, that can be used to set or change the processing core for a thread or task to execute on. For example, in a Linux-based system, APIs that can be used by a software scheduler running on the OS user space may include cgroup, sched_setaffinity and taskset. In a real time OS, such as VxWorks®, a suitable API that can be used by such a software scheduler is taskCpuAffinitySet (taskID, core number). In some embodiments, where the scheduler may run on a kernel space of the OS, other suitable APIs may be utilized by the scheduler to dispatch threads to the processing cores.

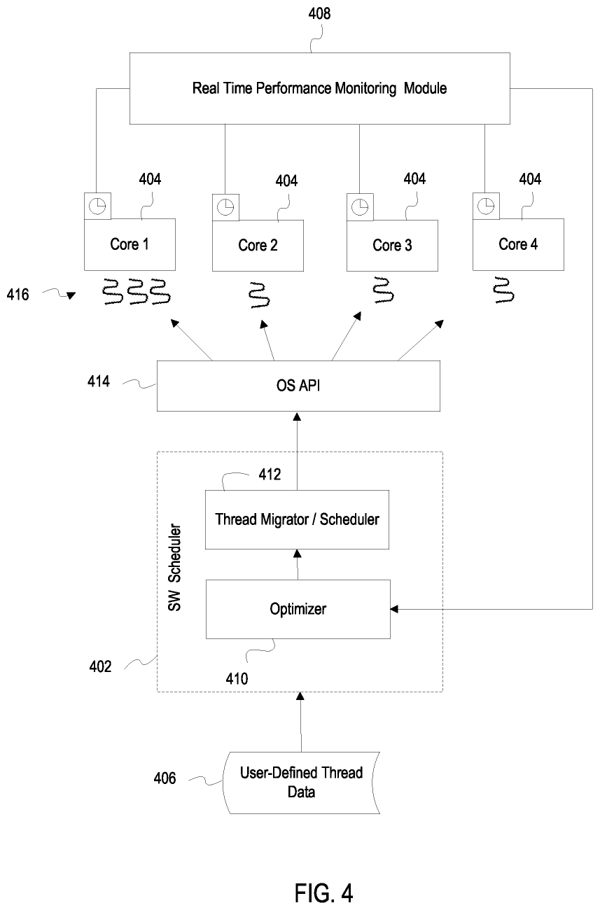

FIG. 4 illustrates a second embodiment of a software scheduler 402 configured to schedule execution of one or more application programs (e.g., control apps) on multiple processing cores 404 of a multi-core processing system, considering real time performance of the processing cores 404. Each application program may execute one or more processes at runtime, each process defined by one or more user-level threads. The software scheduler 402 may be part of a system service that allows a user to define the application threads and set parameters such as core affinity, task priority, task loop time, etc. Accordingly, the software scheduler 402 may have access to user-defined thread data 406 via a user input device. The software scheduler 402 may run on a user space of the processing system OS.

The software scheduler 402 may further have access to a real time performance metric associated with the individual processing cores 404. In closed-loop control systems, tasks are usually cyclical and required to be executed at constant time intervals. For control applications implemented with periodic tasks, the monitored real time performance metric may include parameters that influence periodicity and can cause performance degradation. Accordingly, in some embodiments, the monitored real time performance metric may include, per processing core, a measurement of one or more of the following, namely deadline misses, jitter, and memory utilization, as well as other measurements, such as CPU load.

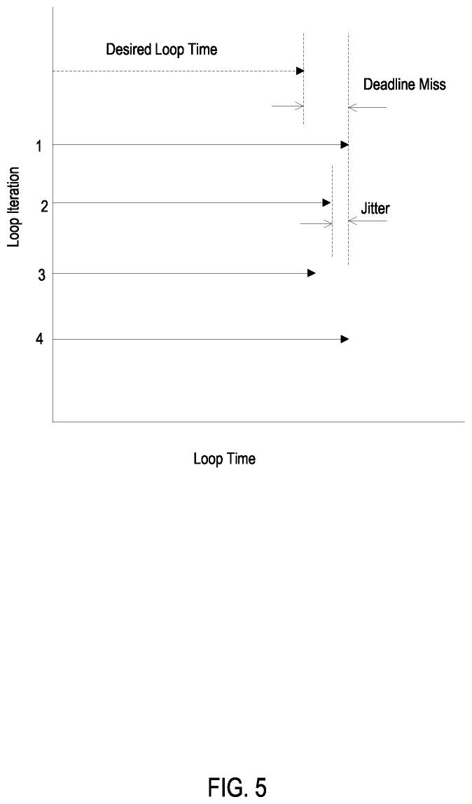

As shown in FIG. 5, tasks in a control application may be iterated in loops with a desired loop time (e.g., every 1 millisecond). The loop time may, for example, be defined by the user based on domain knowledge. As illustrated, a deadline miss is said to occur if the runtime of a loop iteration exceeds the desired loop time. Deadline misses may be expressed, for example, as the number of misses per minute (or any other defined interval) per core. On the other hand, jitter is measured as the amount of error in the timing of a task over subsequent iterations of a program or loop, as illustrated in FIG. 5. Jitter may thus be defined as a measure of variability of task latency. A higher jitter may be indicative of a lower degree of determinism in the execution of the task, for example, due to interruptions or random processes executing on the hardware.

Real time performance monitoring is available, to an extent in the state-of-the-art, for measuring timing, jitter, as well as memory utilization per core, CPU load, etc. However, such state-of-the-art measurements are passive with no feedback to a scheduler to adjust a software's behavior to suit different hardware during runtime.

Referring back to FIG. 4, the measurements pertaining to the real time performance metric (e.g., deadline misses, jitter, memory utilization, CPU load etc.) may be continuously monitored during runtime by a real time performance monitoring module 408 that may be coupled to a system clock. The software scheduler 402 may dynamically allocate processing cores 404 to user-level threads of the one or more application programs taking into consideration the real time performance of the processing cores 404 monitored during runtime. Similar to the previous embodiment, the software scheduler 402 may comprise a first layer including an optimizer 410 and a second layer including a thread migrator 412.

The optimizer 410 may dynamically determine optimal scheduling parameters per thread (e.g., processing core to execute on, sleeping time, cyclic time, etc.) using the monitored real time performance metric of the individual processing cores 404. In one example, the optimizer 410 may be configured to determine optimal scheduling parameters that can minimize jitters, such that real time constraints (e.g., real time task deadlines, CPU load limit, etc.) are met.

According to disclosed embodiments, a software-defined control system may run on a general-purpose OS, which, unlike in a real time OS, may have a number of normal (non-critical) processes that may compete with the control applications for CPU time and memory access. By implementing a software scheduler to intelligently schedule tasks based on measurement of jitter, deadline misses or other real time performance metrices, a software-defined control system can deliver improved performance for real time applications.

In one embodiment, the optimizer 410 may comprise a rule-based optimizer, which may be computationally light and therefore suitable for a runtime scheduler. The rule-based optimizer 410 may be designed based on the above-described optimization problem. As an illustrative example, consider the scenario shown in FIG. 4, where a user has scheduled core 1 with more threads/tasks than the remaining cores. The real time performance monitoring module 408 may observe more deadline misses and/or jitter on core 1 and provide such feedback to the rule-based optimizer 410. Based on the feedback, the rule-based optimizer 410 may determine scheduling parameters to move some of the threads from core 1 to core 2, while the real time performance monitoring module 408 keeps monitoring the impact of each action.

The thread migrator 412 may comprise, for example, a state-of-the-art thread scheduling algorithm to dynamically migrate or switch user-level threads 416 to allocated processing cores 404 based on the optimal scheduling parameters determined by the optimizer 410. Based on the output of the thread migrator 412, user-level threads 416 may be dispatched for execution on respective processing cores 404 via a suitable OS API 414 (e.g., as described above).

According to a third embodiment, a software level scheduler may be configured to schedule execution of the user-level threads on the processing cores based on a hardware limit metric and a real time performance metric associated with the individual processing cores that are monitored during runtime. In this case, a combination of a hardware limit monitoring module (shown in FIG. 2) and a real time performance measurement module (shown in FIG. 4) may be used to provide feedback to the software scheduler, based on which the software scheduler may dynamically allocate processing cores to user-level threads of the application(s) being run.

As in the first and second embodiments, the software scheduler according to the third embodiment may comprise a first layer including an optimizer and a second layer including a thread migrator. The optimizer may dynamically determine optimal scheduling parameters using the monitored metrices. The optimizer, in this case, may be based on an optimization problem defined by a combination of the hardware limit metric and the real time performance metric associated with the individual processing cores. For example, the optimization problem may be formulated as:

$${{min}_{x : \{ Scheduling Parameters \}} ( core\_temperature + real\_time \_jitter )}_{x}$$

$$Such that : real time performance constraints are met , and$$

$$CPU utilization < limit ; CPU temperature < shutoff Temp .$$

The optimizer may comprise a rule-based optimizer, which may be designed based on an optimization problem in which the real time performance is intertwined with the thermal limit of the hardware. As an illustrative example, a rule-based optimizer may be designed to determine scheduling parameters such that hard real time threads that should not be interrupted may be scheduled on a core that has the most stable thermal conditions, while certain other threads with high computing demand and less real time requirement may be scheduled on other cores, and the executions of those threads also consider the thermal inertia of the core.

Again, similar to the previous embodiments, the thread migrator may dynamically migrate user-level threads to allocated processing cores based on the determined optimal scheduling parameters. Based on the output of the thread migrator, user-level threads may be dispatched for execution on respective processing cores via a suitable OS API.

A further aspect of the disclosure is directed to a software task planner for a multi-core processing system. It is recognized that in closed-loop control systems, even with software-defined controllers, most control applications may still involve cyclic tasks. Based on this understanding, the thermal and computing footprint of the control application(s) can, in many situations, be predetermined during the commissioning phase. A software task planner can thus be built that can pre-allocate processing cores and resources to one or more applications in the commissioning phase.

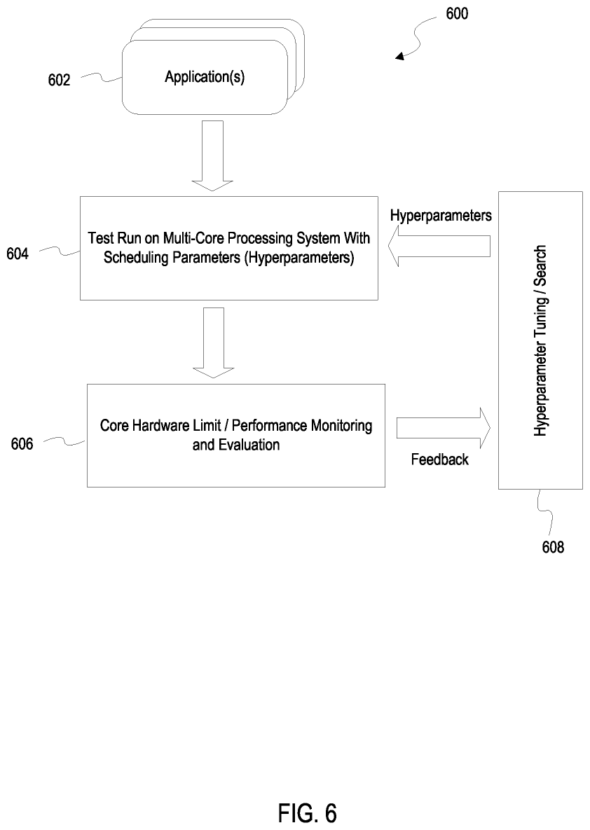

FIG. 6 illustrates a method 600 to build a software task planner according to an example embodiment. The various activities of the method 600 as described herein, including components thereof, may be implemented by a multi-core processing system in various ways, for example, as hardware and programming. The programming for the activities may take the form of processor-executable instructions stored on non-transitory machine-readable storage mediums and the hardware for the engines may include processors to execute those instructions.

Activity 604 includes test running one or more applications 602 on the multi-core processing system using a scheduling policy defined by a set of scheduling parameters (e.g., as described above) to allocate resources of the multi-core processing system to user-level threads of the application(s) 602. The scheduling parameters, in this case, define hyperparameters (i.e., remain fixed) for the test run.

Activity 606 includes monitoring of a hardware limit metric and/or a real time performance metric associated with individual processing cores (e.g., as described above). The measured metrices may be used to evaluate an optimization objective (e.g., a cost function). In one embodiment, the optimization objective/cost function may be defined by a combination of the measured hardware limit metric and the measured real time performance metric associated with the individual processing cores, as described above in connection with the third embodiment.

Activity 608 includes executing a hyperparameter tuning algorithm to adjust the set of hyperparameters based on the evaluated optimization objective. The hyperparameter tuning algorithm may include, for example, a grid search algorithm, a Latin Hypercube sampling algorithm, a Monte Carlo search algorithm, among others. The above-mentioned algorithms are particularly suitable where a mathematical model describing the system behavior is not available, as in the present case.

Activities 604, 606, 608 may be performed iteratively until a convergence criterion is met. The convergence criterion may include, for example, a specified number of steps of iteration, a minimum delta (difference) in the evaluation of the optimization objective between successive iterations, among others. Upon convergence, a set of optimized scheduling parameters may be obtained defining an optimal scheduling policy. The optimal scheduling policy can be configured as a task planner to pre-allocate resources for running the one or more applications on the multi-core processing system.

A software task planner developed offline can enable a control system to run predicably without online monitoring of hardware limit or real time performance. However, in case of unpredictable operating conditions (e.g., extreme ambient temperature changes), a dynamic software scheduler, as described above, may offer better real time performance. In that case, the scheduling parameters of the software task planner can still provide a near optimum starting point.

Thus, according to one embodiment, in a deployment phase, the scheduling parameters of the software task planner can be used for an initial allocation of resources for running the application(s) on the multi-core processing system. A software scheduler (e.g., as described above) may access the hardware limit metric and/or the real time performance metric associated with the individual processing cores monitored during runtime of the application(s). The software scheduler may include an optimizer to further tune the scheduling parameters dynamically based on the monitored metrices, and a thread migrator to dynamically migrate user-level threads to allocated processing cores based on the determined optimal scheduling parameters, as described above. The optimizer is desirably computationally light, for example, including a ruler-based optimizer, or an optimization algorithm based on a linearized model around the setting (scheduling parameters) defined by the software task planner.

The embodiments of the present disclosure may be implemented with any combination of hardware and software. In addition, the embodiments of the present disclosure may be included in an article of manufacture (e.g., one or more computer program products) having, for example, a non-transitory computer-readable storage medium. The computer readable storage medium has embodied therein, for instance, computer readable program instructions for providing and facilitating the mechanisms of the embodiments of the present disclosure. The article of manufacture can be included as part of a computer system or sold separately.

The computer readable storage medium can include a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. Computer readable program instructions described herein can be downloaded to respective computing/processing devices from a computer readable storage medium or to an external computer or external storage device via a network, for example, the Internet, a local area network, a wide area network and/or a wireless network.

The system and processes of the figures are not exclusive. Other systems, processes and menus may be derived in accordance with the principles of the disclosure to accomplish the same objectives. Although this disclosure has been described with reference to particular embodiments, it is to be understood that the embodiments and variations shown and described herein are for illustration purposes only. Modifications to the current design may be implemented by those skilled in the art, without departing from the scope of the appended claims.

1. A multi-core processing system comprising:
a processing unit comprising a plurality of distinct processing cores, and
a memory coupled to the processing unit, the memory comprising instructions defining modules executable by the processing unit, the modules comprising:
an application program configured to execute one or more processes at runtime, each process defined by one or more user-level threads, and
a software scheduler configured to schedule execution of the user-level threads on the processing cores by:
accessing a hardware limit metric and/or a real time performance metric associated with individual processing cores monitored during runtime,
dynamically allocating processing cores to the user-level threads based on the monitored hardware limit metric and/or the real time performance metric associated with the individual processing cores, and
dispatching the user-level threads for execution on respective processing cores based on the allocation.

2. The multi-core processing system according to claim 1, wherein the monitored hardware limit metric is indicative of a temperature of each processing core.

3. The multi-core processing system according to claim 1, wherein the hardware limit parameter is monitored via measurement signals pertaining to one or more of: core temperature, core voltage and core current.

4. The multi-core processing system according to claim 1, wherein the monitored real performance metric includes, per processing core, a measurement of one or more of: deadline misses, jitter and memory utilization.

5. The multi-core processing system according to claim 1,
wherein the hardware limit metric and the real time performance metric associated with the individual processing cores are both monitored during runtime, and
wherein the processing cores are dynamically allocated to the user-level threads based on the monitored hardware limit metric and the real time performance metric associated with the individual processing cores.

6. The multi-core processing system according to claim 5, wherein the software scheduler comprises:
an optimizer configured to dynamically determine optimal scheduling parameters using the monitored metrices based on an optimization objective defined by a combination of the hardware limit metric and the real time performance metric associated with the individual processing cores, and
a thread migrator configured to dynamically migrate user-level threads to allocated processing cores based on the determined optimal scheduling parameters.

7. The multi-core processing system according to claim 6, wherein the scheduling parameters comprise, per user-level thread, one or more of: processing core to execute on, sleeping time and cyclic time.

8. The multi-core processing system according to claim 6, wherein the optimizer comprises a rule-based optimizer.

9. The multi-core processing system according to claim 1, wherein the software scheduler runs on a user space of an operating system of the multi-core processing system.

10. The multi-core processing system according to claim 9, wherein the operating system is a general-purpose operating system.

11. The multi-core processing system according to claim 1, wherein the multi-core processing system is an industrial control system.

12. A method for allocating resources to an application program running on a multi-core processing system, the method comprising:
accessing a hardware limit metric and/or a real time performance metric associated with individual processing cores of the multi-core processing system monitored during runtime,
dynamically allocating processing cores to user-level threads of the application program, taking into consideration the monitored hardware limit metric and/or the real time performance metric associated with the individual processing cores, and
dispatching the user-level threads for execution on respective processing cores based on the allocation.

13. A non-transitory computer-readable storage medium including instructions that, when processed by a multi-core processing system, configure the multi-core processing system to perform the method according to claim 12.

14. A method for allocating resources in a multi-core processing system, comprising:
building a software task planner during a commissioning phase by performing, over a number of iterations:
test running one or more application programs on the multi-core processing system using a scheduling policy defined by a set of scheduling parameters to allocate resources of the multi-core processing system to user-level threads of the one or more application programs, wherein scheduling parameters define hyperparameters for the test run,
evaluating an optimization objective based on monitoring of a hardware limit metric and/or a real time performance metric associated with individual processing cores, and
executing a hyperparameter tuning algorithm to adjust the set of hyperparameters based on the evaluated optimization objective,
wherein the iterations result in a set of optimized scheduling parameters defining an optimal scheduling policy, the optimal scheduling policy configured as a task planner to pre-allocate resources for running the one or more application programs on the multi-core processing system.

15. The method according to claim 14, wherein the hyperparameters comprise, per user-level thread, one or more of: processing core to execute on, sleeping time and cyclic time.

16. The method according to claim 14, wherein the hyperparameter tuning algorithm is selected from the group consisting of: a grid search algorithm, a Latin Hypercube sampling algorithm and a Monte Carlo search algorithm.

17. The method according to claim 14, wherein the optimization objective is defined by a combination of the measured hardware limit metric and the measured real time performance metric associated with the individual processing cores,

18. The method according to claim 14, subsequently comprising:
using the scheduling parameters of the task planner for an initial allocation of resources for running the one or more application programs on the multi-core processing system,
accessing the hardware limit metric and/or the real time performance metric associated with the individual processing cores monitored during runtime of the one or more applications,
using an optimizer to further tune the scheduling parameters dynamically based on the monitored metrices, and
using a thread migrator to dynamically migrate user-level threads to allocated processing cores based on the determined optimal scheduling parameters.

19. The method according to claim 18, wherein the optimizer comprises a rule-based optimizer.

20. A non-transitory computer-readable storage medium including instructions that, when processed by a multi-core processing system, configure the multi-core processing system to perform the method according to claim 14.
